(19) United States
(12) Patent Application Publication
(10) Pub. No.: US 2009/0078009 A1
(43) Pub. Date: Mar. 26, 2009

(54) Bicycle with integrated bike-locking mechanism

(76) Inventor: Charlotte Docking, London (GB)

Correspondence Address: LAW OFFICE OF KYLE FLETCHER, P.O. Box 11735, CHARLOTTE, NC, 28220, US

(21) Appl. No.: 11/903,319

(22) Filed: Sep. 21, 2007

(51) Int. Cl. E05B 71/00

(52) U.S. Cl. 70/15

(57) ABSTRACT

The invention is a bicycle frame having an integrated bicycle locking mechanism. Roughly mid-length of a tube of the bicycle frame is removed in order to accommodate the locking mechanism. Secured within one of the exposed ends of the frame is a flexible wire that can emerge and lock itself to a locking receptacle located on the other open end of the frame. Located on the exposed end of the flexible linkage is the locking mechanism. The invention is designed so as to enable the flexible wire to wrap around a stationary object, such as a pole or bicycle stand. Alternatively, the flexible wire can wrap around the rear wheel of the bicycle so as to prevent the bicycle from being used.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to the field of bicycle locks, more specifically, a bicycle with an integrated bicycle locking mechanism.

B. Discussion of the Prior Art

The Noer patent (U.S. Pat. No. 6,948,731) discloses a bicycle frame having a pivotal tube such that the tube can be moved so that the bicycle can be secured around a post or such and then the tube returned to the original position as to secure the bicycle to the post. However, the bicycle disclosed under the Noer patent does not have a locking mechanism integrated into the movable pivotal tube.

The Hoffman patent (U.S. Pat. No. 6,505,846) discloses a bicycle cable locking system wherein the cable for securing the bicycle is stored inside the frame tubing. However, the cable locking system disclosed under the Hoffman patent does not utilize a bicycle frame that has an open section of which the locking mechanism consumes when the locking mechanism is not in use, and of which can be unlocked and enable the locking linkage to exit from the bicycle frame in order to lock the bicycle to a secure object.

The Lundberg patent (U.S. Pat. No. 4,870,843) discloses a combined tether and cylinder lock for locking a bicycle wherein the tether and lock are stored in the bicycles hollow handlebar. However, the tether and cylinder lock disclosed under the Lundberg patent are situated about the handlebar, and are not integrated into the lower frame of the bicycle.

The Gould patent (U.S. Pat. No. 4,023,387) discloses a cable storing and retrieving system to be mounted to the frame of a bicycle. However, the cable storing and retrieving system disclosed under the Gould patent does not is an system that is mounted onto an existing bicycle frame and is not integrated into the design of the bicycle frame.

The Kelly patent (U.S. Pat. No. 3,814,462) discloses a bicycle frame having a two piece crossbar with a locking mechanism that holds the two pieces together in an operative state wherein the crossbar can be separated so as to secure the bicycle around a permanent post-like object and then reconnected and locked so as to secure the bicycle. However, the bicycle frame disclosed under the Kelly patent does not use a flexible locking linkage that rests within the frame of the bicycle wherein the flexible linkage can extend outwardly from the frame and wrap around a secure object wherein the ends of the flexible linkage lock together thereby securing the bicycle.

The Wilson et al. patent application Publication (U.S. Pub. No. 2002/0073751) discloses a cable locking device designed to be fitted into the end of a bicycle handlebar. As discussed with the Lundberg patent above, the cable locking device disclosed under the Wilson Publication is located in the handlebar and is not integrated into the design of the lower frame of the bicycle.

The Arblaster patent (U.S. Pat. No. 4,024,741) discloses a cable locking device for a bicycle wherein the locking bolt and cable are stored inside the handlebar of the bicycle. Again, the cable locking device disclosed under the Arblaster patent, as disclosed under the Lundberg patent and Wilson Publication, places the locking mechanism in the handlebar of the bicycle, as opposed to integrating the locking mechanism into the design of the lower portion of the frame of the bicycle.

The Zapushek patent (U.S. Pat. No. Des. 461,392) illustrates a pin lock having a similar structure as the pin lock used disclosed under this patent application. However, the Zapushek patent does not illustrate how the pin lock unlocks and separates.

The Hardesty patent (U.S. Pat. No. Des. 451,363) illustrates a bicycle locking device having a retractable cable.

In light of the above discussed prior art there is a need for a bicycle frame that incorporates a locking mechanism into the design of the bicycle frame from which a flexible linkage emerges and can be wrapped around a secure object, and thereafter retract within the frame when not in use.

### BRIEF SUMMARY OF THE INVENTION

The invention is a bicycle frame having an integrated bicycle locking mechanism. Roughly mid-length of a tube of the bicycle frame is removed in order to accommodate the locking mechanism. Secured within one of the exposed ends of the frame is a flexible wire that can emerge and lock itself to a locking receptacle located on the other open end of the frame. Located on the exposed end of the flexible linkage is the locking mechanism. The invention is designed so as to enable the flexible wire to wrap around a stationary object, such as a pole or bicycle stand. Alternatively, the flexible wire can wrap around the rear wheel of the bicycle so as to prevent the bicycle from being used.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a side view of the invention;

FIG. 2 illustrates an isometric view of the invention in use;

FIG. 3 illustrates a detailed front view of the Locking mechanism and the flexible linkage; and

FIG. 4 illustrates a detailed cut away view of the invention.

### DETAILED DESCRIPTION OF THE EMBODIMENT

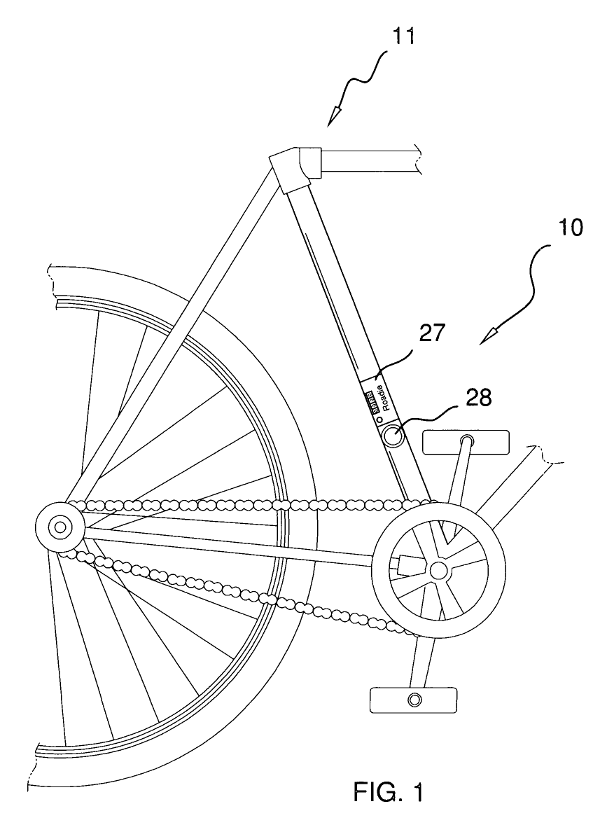

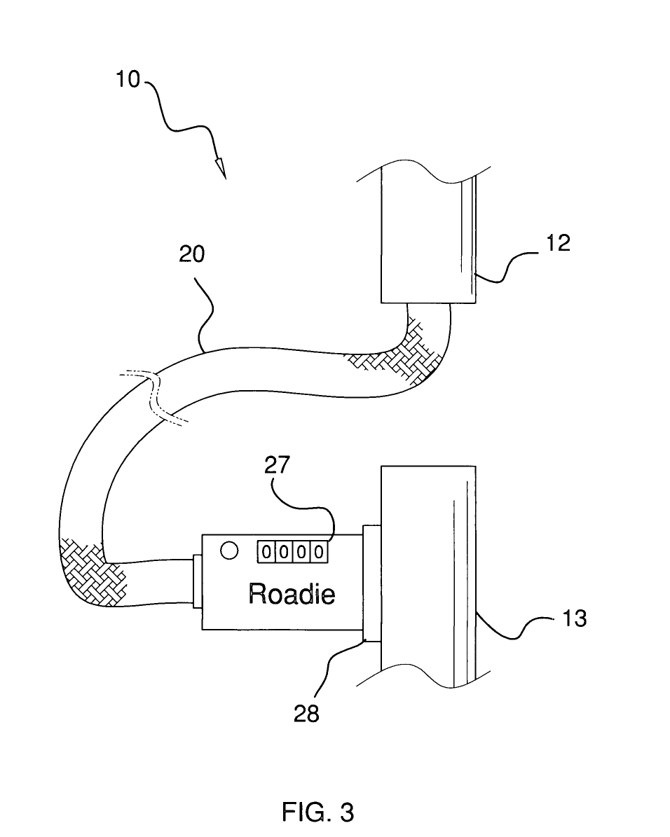

Detailed reference will now be made to the preferred embodiment of the present invention, examples of which are illustrated in FIG. 1-4. A bicycle locking system 10 (hereinafter invention) includes a bicycle frame 11 having a cut-out section consisting of a left frame piece 12 and a right frame piece 13. It shall be noted that the bicycle frame 11 consists of hollow, tubular pieces. Located at the open end of the left frame piece 12 is a lip 15.

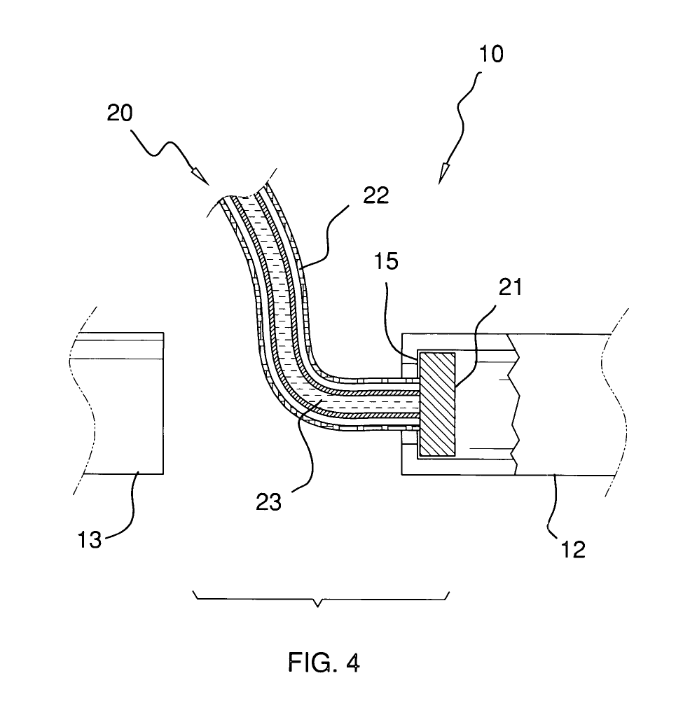

Located within the left frame piece 12 is a flexible line 20, which has a stop 21 permanently affixed to an end of the flexible line 20. The stop 21 prevents the flexible line 20 from completely exiting the left frame piece 12 as depicted in FIG. 4.

The flexible line 20 consists of a flexible exterior wire 22 and an interior wire 23 that connects to the stop 21. The flexible exterior wire 22 shall be made from a woven durable metal that resists oxidation, is lightweight, and shields the interior wire 23 from the elements as well as from a shearing force. The interior wire 23 shall be made of a flexible tool strength metal.

Located at the opposite end of the flexible line 20 is a locking mechanism 27. The locking mechanism 27 is permanently secured to the opposite end of the flexible line 20, and may incorporate a variety of locking configurations, such as a lock-key, or combination lock.

When the invention 10 is not in use, the locking mechanism 27 is designed to fit within the opening between the ends of the left frame piece 12 and the right frame piece 13. It is being asserted that the principal benefit of the invention 10 is that the flexible line 20 retracts into the bicycle frame 11 and the locking mechanism 27 restores the void between the left and right frame 12, 13 so as to restore the integrity of the bicycle frame 11.

Located along the exterior surface of the right frame piece 13 is a locking receptacle 28, which is designed to receive the locking mechanism 27.

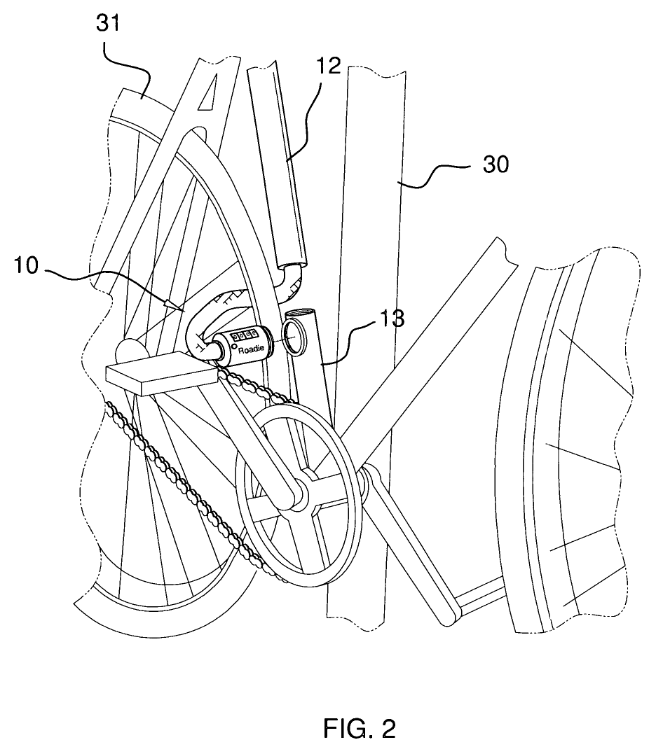

The invention 10 is used by removing the locking mechanism 27 from the void between the left frame piece 12 and the right frame piece 13. Next, the flexible wire 20 is either wrapped around a stationary object 30 (not depicted in FIG. 2) and/or the flexible wire 20 is wrapped around a rear wheel 31 of the bicycle. Finally, the locking mechanism 27 is locked onto the locking receptacle 28.

It shall be noted that the location of the locking receptacle 28 may be positioned at other locations on the bicycle frame 11 so as to secure other portions of the bicycle frame 11. It shall be further assumed that the invention 10 may include a plurality of locking receptacles 28 that are located throughout the bicycle frame 11 so as to provide the end user with a plurality of options in order to secure the bicycle frame 11 to a variety of stationary objects (not depicted).

It shall be noted that the invention 10 can be designed into the manufacturing of the bicycle or that the invention 10 can be an after-market product that is installed on an existing bicycle.

It shall be noted that variations and alternatives of the present embodiment are readily apparent to those of ordinary skill in the art upon reading the present disclosure, and such variations and alternatives including equivalent structures and structural equivalents are incorporated in the invention unless otherwise expressly indicated in the claims.

While the embodiments of the invention have been disclosed, certain modifications may be made by those skilled in the art to modify the invention without departing from the spirit of the invention.

The inventor claims:

1. A bicycle with integrated bike-locking mechanism comprising:
(a) a bicycle frame made of a hollow tubular construction;
wherein a section of the frame has a cut-out leaving a left frame piece and a right frame piece;
wherein located about the end of the left frame piece is a lip;
(b) a flexible wire;
wherein the flexible wire has an overall length sufficient to enable the flexible wire to wrap around either the front wheel or the rear wheel of the bicycle and/or a stationary object located within the immediate vicinity of the bicycle;
wherein the flexible wire consists of a flexible, exterior wire, and a flexible, interior wire;
wherein the flexible, exterior wire is made of a woven metal of durable construction that resists oxidation and covers the flexible, interior wire;
wherein securely fastened at one end of the interior, flexible wire is a stop that rests entirely within the left frame piece and cannot exit the opening of the left frame piece due to the lip on the left frame piece;
wherein a locking mechanism is permanently affixed to the opposite end of the flexible, interior wire;
wherein the flexible wire can retract up into the left frame piece, and wherein the locking mechanism can fill in the opening between the left frame piece and the right frame piece;
(c) a locking receptacle;
wherein the locking receptacle is located along the exterior surface of the right frame piece, immediately adjacent to the opening in the bicycle frame; and
wherein the locking receptacle is designed to receive and secure the locking mechanism.

2. The bicycle with integrated bike-locking mechanism as described in claim 1 wherein the flexible, exterior wire are made from a lightweight yet strong material comprising metal or a durable plastic.

3. The bicycle with integrated bike-locking mechanism as described in claim 1 wherein the flexible, interior wire is made from a tool strength metal.

4. The bicycle with integrated bike-locking mechanism as described in claim 1 wherein the locking mechanism contains a key and lock configuration.

5. The bicycle with integrated bike-locking mechanism as described in claim 1 wherein the locking mechanism contains a combination lock configuration.

6. The bicycle with integrated bike-locking mechanism as described in claim 1 wherein a plurality of locking receptacles are mounted at various locations along the frame of the bicycle.
